(19) United States
(12) Patent Application Publication
(10) Pub. No.: US 2003/0029944 A1
(43) Pub. Date: Feb. 13, 2003

(54) Method and apparatus for facilitating recovery of desired materials from ore

(76) Inventors: Darrin Flinn, Morenci, AZ (US); Erol Kaya, Safford, AZ (US); Paul Spradlin, Safford, AZ (US)

Correspondence Address: Snell & Wilmer L.L.P., One Arizona Center, 400 East Van Buren, Phoenix, AZ, 85004-2202, US

(21) Appl. No.: 09/521,839

(22) Filed: Mar. 9, 2000

(51) Int. Cl. B02C 19/00

(52) U.S. Cl. 241/1

(57) ABSTRACT

Method and apparatus for assisting recovery of desired materials from ore are disclosed. Desired material liberation is assisted by applying high power microwave energy to the ore. Application of high power microwave energy causes materials within the ore to react with gaseous compounds in the air to form a plasma. The plasma is retained proximate the ore to facilitate heating of the ore to induce stress formation within the ore and/or mineral oxidation of ore materials. The additional heat, stresses, and fractures caused via application of the high power microwaves facilitate desired material liberation from the ore during subsequent material extraction processes.

### FIELD OF THE INVENTION

The present invention generally relates to extracting materials from ore. More particularly, the present invention relates to methods and apparatus for treating ore with electromagnetic energy to facilitate recovery of desired materials from the ore.

### BACKGROUND OF THE INVENTION

Material (e.g., mineral and/or metal) production generally includes mining to remove ore from the earth, comminution to reduce the size of the ore for subsequent processing, and chemical treatment to liberate the desired material from the ore. Although mining, comminution, and chemical treatment steps, as well as the sequence of these steps, may vary in accordance with several factors such as the type of ore, the type of material to be extracted from the ore, desired ore size reduction, and subsequent mineral extraction processing, it is often desirable to select processes and process sequences to minimize material production costs per amount of material recovered.

Comminution of ore generally includes application of a compressive force to the ore to reduce the size of and increase material recovery from the ore. Such compressive comminution processes are generally energy intensive. In addition, compressive comminution is generally inefficient. Specifically, for typical comminution processes, only about 1% to 5% of the energy applied to ore during the comminution process goes toward reducing ore size, while about 95% to 99% of the energy is wasted in the form of heat generated in the ore and the comminution equipment. Accordingly, improved material extraction processes with more efficient, less energy consuming comminution processes are desired.

Recently, new techniques have been developed in an attempt to reduce a total amount of energy required to extract an amount of a desired material from an amount of ore. For example, low power microwaves generators (e.g., generators that produce power levels of less than 2 kW) have been applied to ore in an attempt to reduce an amount of energy required during comminution and hence reduce overall energy consumption during material extraction processing.

The application of low power microwaves to ore facilitates comminution of the ore by promoting fracture of the ore along mineral grain boundaries (as opposed to indiscriminate fracture characteristic of conventional comminution techniques). Fracture along the grain boundaries is promoted, at least in part, because different ore materials (e.g., gangue and the mineral oxides and sulfides) absorb varying amounts of microwave radiation. For example, gangue material within an ore may be substantially transparent to the microwaves, while mineral oxides and/or sulfides within the ore absorb and therefore readily heat upon application of microwaves to the ore. This temperature differential between the gangue and mineral oxides and/or sulfides of the ore produces tensile and/or compressive stresses within the ore, and these stresses facilitate fracture of and material liberation from the ore. In addition, application of microwaves to ores may facilitate oxidation reactions along the grain boundaries (e.g., oxidation of mineral sulfides), and the oxidation reaction may cause liberation of gasses such as sulfur dioxide. This liberation of gasses produces tensile stresses within the ore which weakens the ore and thus facilitates fracture of and material liberation from the ore.

Although application of low power microwaves to ore is thought to increase an amount of desired material recovered from an amount of ore for a given amount of energy, microwave-assisted material recovery using low power microwaves may be problematic in several regards. In particular, to effect desired material liberation from ore, low power microwaves are often applied to the ore for a relatively long period of time. Application of microwaves to ore for a long time period may cause undesired oxidation of sulfur or other compounds within the ore. Such oxidation may detrimentally affect desired material extraction during subsequent chemical treatment of the ore. Further, application of low power microwaves to ore may be relatively inefficient at enhancing an amount of desired material extracted from an amount of ore for a given amount of energy. In particular, low power microwave energy generally only heats materials such as mineral sulfide and oxides that absorb microwaves. Material that is relatively resistant to absorbing microwaves is heated primarily via conduction and convection. The time period during which radiation is applied to the ore may not be sufficient to heat the bulk (e.g., gangue material) of the ore. Heating the bulk of the ore may be desirable because it may generate additional thermal-induced fractures within the ore, and these additional fractures may further aid comminution and liberation of desired materials. Accordingly, improved apparatus and methods for recovering desired materials from ore are desired. In addition, methods and apparatus that facilitate heating of gangue and other material within the ore are also desired.

### SUMMARY OF THE INVENTION

The present invention provides improved method and apparatus for recovering desired materials from ore. More particularly, the invention provides a material extraction method which uses high power microwave energy to facilitate material liberation from ore and to an apparatus for applying the energy to the ore.

In accordance with an exemplary embodiment of the present invention, crushed ore is exposed to high power microwave energy for a period of time sufficient to facilitate recovery of desired materials such as minerals and metal from the ore. In accordance with one aspect of this embodiment, the microwave energy power level is sufficient to react with materials in the ore to produce a plasma. In accordance with a further aspect of this embodiment, the plasma is retained proximate the ore for a period of time, such that the plasma contributes to the heating of the ore. Heating the ore by retaining the plasma proximate the ore facilitates formation of additional stresses within the ore, which in turn facilitate comminution of and recovery of desired materials from the ore. In addition, application of high power microwave energy to the ore facilitates oxidation of sulfides and other ore materials, which in turn may facilitate desired material recovery.

In accordance with another exemplary embodiment of the present invention, microwave energy is applied to ore within a flow through container, a chute, or the like. In accordance with one aspect of this embodiment, microwave energy is applied to ore near the bottom of the chute, and plasma formed near the bottom is allowed to rise toward the top of the chute. Allowing the plasma to rise through the chute facilitates thermal energy transfer from the area near the bottom of the chute toward the top of the chute, such that ore above the region where microwave energy is introduced to the chute is heated. This heating of the ore facilitates comminution and recovery of desired ore materials during subsequent processing.

In accordance with another embodiment of the present invention, a sulfur dioxide scrubber is placed proximate ore treated with microwave plasma to remove sulfur dioxide from the chute effluent. In accordance with a further aspect of this embodiment, water is added to the ore to reduce an amount of microwave energy that escapes from an area containing the ore being treated with microwave energy.

In accordance with yet another embodiment of the present invention, water or other fluid may be added to the ore prior to or during application of microwave power to the ore. The fluid absorbs the microwave energy and thus heats upon application of microwaves to the fluid, facilitating formation of additional stresses within the ore. The formation of additional stresses increases recovery of the desired ore materials. In accordance with one aspect of this embodiment, ore is placed within a chute and fluid is applied to the ore proximate the top of the chute. Applying fluid proximate the top of the container facilitates maintaining the plasma proximate the bottom of the chute, which reduces undesired emission of microwave energy away from the chute.

### BRIEF DESCRIPTION OF THE DRAWINGS

A more complete understanding of the present invention may be derived by referring to the detailed description and claims, considered in connection with the figures, wherein like reference numbers refer to similar elements throughout the figures, and:

FIG. 1 is an illustration of a process for extracting a copper from ore in accordance with an exemplary embodiment of the present invention;

FIG. 2 is an illustration of a process for extracting copper from ore in accordance with an alternative embodiment of the present invention;

FIG. 3 is an illustration of an apparatus configured to apply microwaves to an ore sample in accordance with an exemplary embodiment of the present invention;

FIG. 4A is an illustration of a copper ore sample having a fracture formed therein;

FIG. 4B is an illustration of the copper ore sample of FIG. 4A, showing the ore separated along the fracture; and

FIG. 5 is an illustration of an apparatus configured to apply microwaves to an ore sample in a continuous mode in accordance with the present invention.

### DETAILED DESCRIPTION OF EXEMPLARY EMBODIMENTS

The present invention generally relates to a method and apparatus for recovering desired materials from ore. Although the present invention may be used to extract a variety of materials (e.g., various minerals and/or metals) from a variety of ores (e.g., gold, silver, and iron metals and/or minerals from their respective ores), the present invention is conveniently described below in connection with extracting copper and copper mineral from copper ore.

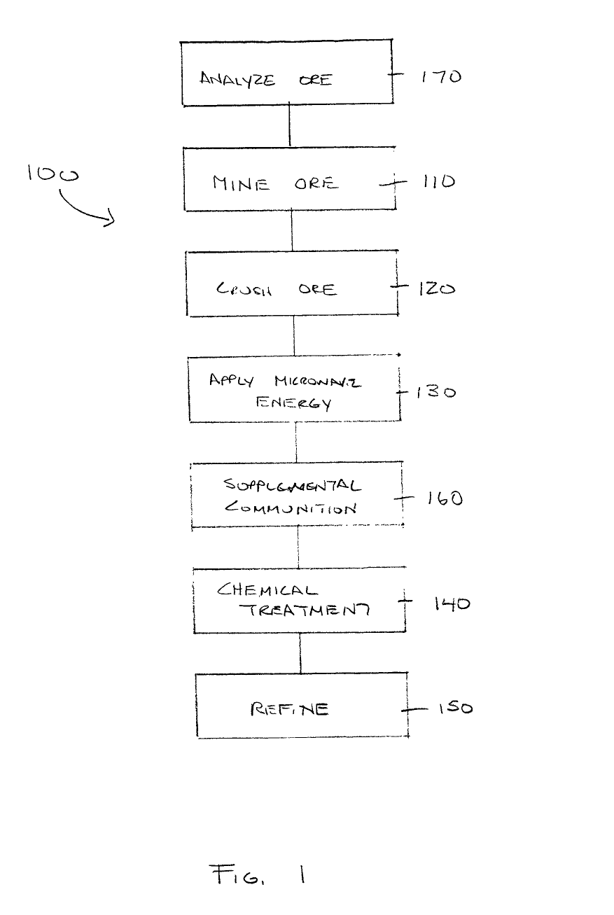

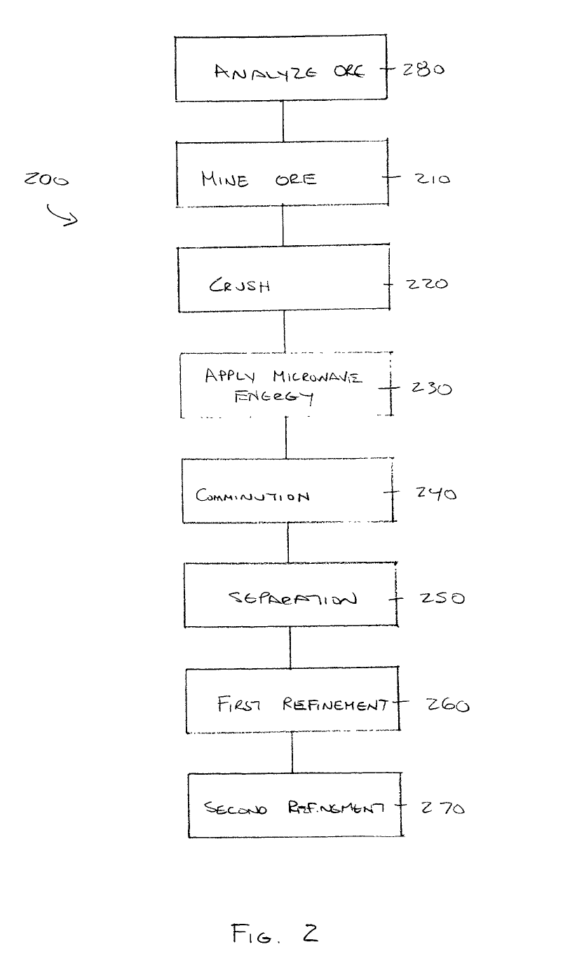

As noted above, methods to liberate desired materials from ore generally include mining, comminution, and chemical treatment processes; and, the parameters and sequence of these processes may vary in accordance with a variety of parameters. For example, comminution and chemical treatment processes may vary in accordance with the grade of ore (percent of desired mineral in the ore). Two exemplary material recovery methods in accordance with the present invention are illustrated in FIGS. 1 and 2, respectively.

A material recovery process 100 for recovering copper from ore, illustrated in FIG. 1, generally includes a mining step 110, a comminution or crush step 120, a microwave application step 130, and a chemical treatment step 140. Process 100 may also suitably include a refining step 150, a second comminution step 160, an analysis step 170, or any combination of these desired additional steps.

Mining step 110 may include any method suitable for removing ore from a site. For example, open pit mining or underground mining techniques may be used to obtain ore from the site. Such mining techniques generally involve exposing the site to an explosive blast to form boulders of ore and removing the boulders from the site.

Crush step 120 is generally configured to reduce an average boulder size for subsequent ore processing. In accordance with an exemplary embodiment of the present invention, step 120 is configured to expose the ore to a compressive force to reduce the size of the ore from a top size of about 48 inches to a top size of about 6 inches. Any suitable crushing equipment (e.g., a jaw crusher or a gyratory crusher) may be used to reduce ore size during step 120, and step 120 may include any suitable number of crushing stages. If desired, any fines produced during step 120 may suitably be removed prior to subsequent ore processing in accordance with process 100.

To facilitate recovery of copper during chemical treatment step 140, crushed copper ore is exposed to microwave radiation during step 130. In accordance with an exemplary embodiment of the present invention, the microwave radiation reacts with species to form a plasma within or proximate the ore. For example, if the ore contains copper sulfides, the ore is exposed to microwave energy sufficient to cause species such as oxygen in the ambient air to react with the mineral sulfides to form a plasma. In accordance with another exemplary embodiment of the invention, sulfur or sulfur containing material may be added to the ore sample to facilitate plasma formation and material recovery. Alternatively, the radiation may react with other compounds such as one ore more gasses surrounding the ore. However, in accordance with other embodiments of the present invention, a plasma may not be formed upon application of high energy microwave energy to the ore sample.

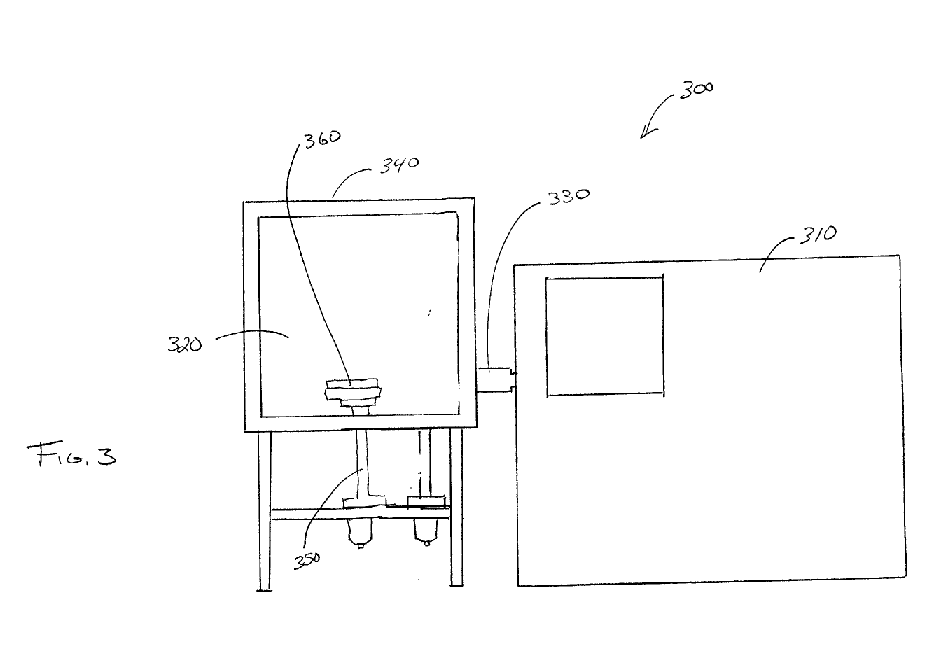

An apparatus 300 suitable for applying high power microwave energy to the ore is illustrated in FIG. 3. Apparatus 300 includes a microwave generator 310, a chamber 320, and a waveguide 330 configured to guide microwaves generated at generator 310 to chamber 320.

Generator 310 may include any apparatus configured to supply high power microwave energy to chamber 320. In accordance with an exemplary embodiment of the present invention, generator 310 is a Microdry Model IV-30 microwave power generator manufactured by Microdry, Inc. In accordance with this embodiment, generator 310 is configured to produce from 0 to about 30 kW of continuous microwave energy at about 2.45 GHZ.

Chamber 320 is generally configured to retain an ore sample during application of microwave energy to the sample. In accordance with an exemplary embodiment of the present invention, chamber 320 includes a compartment 340 designed to hold the ore and prevent unwanted microwave emission and a turntable 350 configured to rotate a sample if desired. In accordance with an exemplary aspect of the present embodiment, compartment 340 is about 3′×3′×12″ and is formed of aluminum and stainless steel.

The power, application time, and frequency of the microwaves applied during step 130 may vary from application to application. In accordance with an exemplary embodiment of the present invention, the ore is exposed to microwave radiation having a power level of about 2 to about 30 kW, a frequency of about 915 MHz or about 2.45 GHz, for about 1 to about 120 seconds. In accordance with an exemplary aspect of this embodiment, the ore is exposed to continuous microwave energy having a power of about 30 kW, a frequency of about 2.45 MHz, for about 30 seconds.

In accordance with another exemplary embodiment of the present invention, the microwave energy may be pulsed (e.g., by diverting the microwaves away from the ore sample for a portion of the pulsed cycle). Pulsing the microwave energy allows the ore to heat during application of the microwave and cool as the microwave energy is turned off or otherwise diverted from the ore. Allowing the ore to heat and cool for multiple cycles may increase stresses and/or fracturing in the ore, which in turn facilitate increased mineral recovery during subsequent processing. In addition, pulsing the microwave energy may increase an effective amount of energy absorbed by the ore, which may also increase an amount of desired material recovered during process 100.

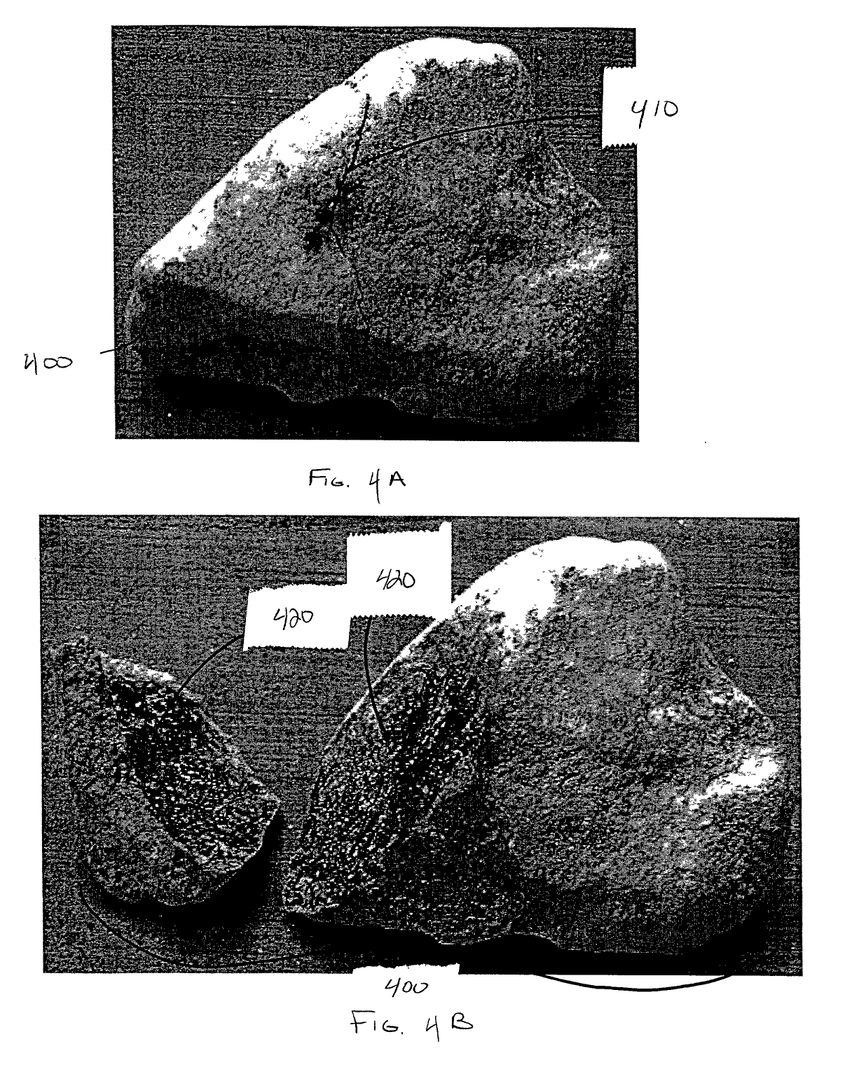

Exposure of ore to microwave energy in accordance with process 100 is thought to increase recovery of copper via one or more of a variety of mechanisms. For example, exposing ore to microwaves causes increased fracturing at a mineral grain. This mode of fracture increases the surface area within the ore which is exposed to reagents used in treatment step 140. This fracturing phenomenon is illustrated in FIG. 4A, which shows a fracture 410 formed within an ore sample 400 after application of microwave energy; and FIG. 4B, which illustrates that fracture 410 occurs to expose new mineral surfaces (e.g., a surface 420) within ore sample 400. Although process 100 facilitates fracturing of the ore, the inventors have found that the inventive process does not produce significantly more fines.

Copper recovery may also be increased upon application of microwaves to ore through a variety of other mechanisms. For example, if treatment step 140 includes leaching with an acidic solution, the oxidation of copper compounds, resulting from plasma heating of the ore, may facilitate leaching of the copper mineral.

To increase an amount of copper recovered per amount of energy applied to an amount of ore, the plasma formed during step 130 is retained proximate at least a portion of the ore for a period of time. Retaining the plasma proximate the ore facilitates additional heating, and thus increases the stresses resulting from a given amount of applied microwave energy to the ore sample. In addition, increased ore heat may facilitate additional formation of SO₂, which may assist copper recovery during subsequent processing.

A container 360 for retaining a plasma proximate an ore sample is illustrated in FIG. 3. Container 360 is suitably constructed of a material that is substantially transparent to microwave energy and which is impervious to the formed plasma. In accordance with an exemplary embodiment of the present invention, container 360 is formed of a ceramic material such as aluminum oxide.

In accordance with an exemplary embodiment of the present invention, a fluid is applied to the ore during step 130. The fluid (e.g., water, acid, or a combination thereof) absorbs microwave energy and thus heats upon application of the energy to the fluid. Heating of the fluid generates pressure within the ore, resulting in the formation of fractures. In addition, because the fluid readily absorbs the microwave energy, the fluid may be used to reduce undesired microwave energy emission from an area proximate the ore sample.

In accordance with one aspect of the present embodiment, after microwave radiation has been applied to the ore, the ore is exposed to chemical treatment step 140. Treatment step 140 generally includes application of one or more reagents that react with mineral compounds (e.g., copper sulfides, copper sulfates, copper oxides, and the like) and assist removal of copper and/or copper mineral from the ore. In accordance with an exemplary embodiment of the present invention, 0.03 to 0.2 molar sulfuric acid is applied to the ore during step 140 to dissolve copper compounds within the ore and form a solution containing copper ions.

A copper solution may be formed in accordance with the present invention by exposing the ore to microwave radiation, placing the ore in a stockpile, and applying acid to the ore stockpile. In accordance with this embodiment, ore fines may detrimentally affect copper recovery. In particular, fines within the stockpile may affect the permeability of reagents through the stockpile and may generate additional dust at the site. Accordingly, in accordance with this embodiment of the invention, process 100 is configured to mitigate production of fines.

In accordance with an alternate embodiment of the present invention, microwave application step 130 and treatment step 140 may suitably be performed simultaneously. In accordance with this embodiment of the invention, fluid reagents which assist desired material removal from ore may also assist preventing emission of microwaves from an application site and heating of the ore sample.

During refining step 150, copper mineral obtained from step 140 is separated from other impurities. In accordance with an exemplary embodiment of the present invention, the copper mineral may be refined using chemical purification and electrodeposition processes.

Process 100 may suitably include additional comminution steps (e.g., step 160). These additional comminution steps may vary in accordance with several factors such as the type of ore, mineral, and comminution equipment. As illustrated in FIG. 1, in accordance with an exemplary embodiment of the present invention, supplemental comminution step 160 may be interposed between microwave application step 130 and chemical treatment step 140. In accordance with this embodiment, microwaves applied during step 130 facilitate further comminution of ore during supplemental comminution step 160. Such additional microwave application steps may include either high or low power microwave radiation.

In accordance with another embodiment of the present invention, a microwave application step may be added to process 100 prior to step 120 to facilitate liberation of desired material. Application of microwave energy prior to step 120 may be in addition to or in lieu of other microwave application steps.

Process 100 may also include analysis step 170. Analysis step 170 is configured to measure an amount of mineral present in the ore. Any suitable mineral analysis method may be used in accordance with step 170 of the present invention, and step 170 may suitably be performed before or after mine step 110.

FIG. 2 illustrates a process 200 for extracting copper from ore in accordance with an alternate embodiment of the present invention. Process 200 suitably includes a mining step 210, a crush step 220, a microwave application step 230, a comminution step 240, and a separation step 250. Process 200 may also suitably include a first refining step 260, a second refining step 270, an analysis step 280, or any combination of these additional steps 260-280.

In general, mine step 210 and crush step 220 are analogous to mine step 110 and crush step 120 described above in connection with process 100. Accordingly, for the sake of brevity, further discussion of these steps is omitted. Further, similar to process 100, any fines produced during step 220 may be separated from ore processed through step 230. Such fines may be reintroduced to process 200 at another time. For example, the fines may be combined with crushed ore at or before separation step 250.

Microwave application step 230 may also be similar to microwave application step 130; however, as discussed in further detail below, unlike process 100 where oxidation of copper compounds may be advantageous and facilitate mineral and/or metal extraction, oxidation of copper compounds during step 230 of process 200 may deleteriously affect copper extraction (e.g., efficiency of separation step 250 may be negatively affected).

To reduce an amount of oxidation during step 230, an amount of microwave power applied to the ore may desirably be reduced. For example, the power may preferably be kept below about 1 kW. In addition, an amount of time the copper ore is exposed to microwave energy may be reduced, as compared to process 100. In particular, a total exposure time of microwave energy to an ore sample may be kept below about 10 seconds. Further, to increase stresses and cracking within the ore, while mitigating oxidation, it may be desirable to pulse application of microwave energy to the ore as described above.

Although application of microwaves to the ore in accordance with process 200 may cause undesired oxidation of copper compounds, the microwave energy may heat portions of the ore, causing heat-induced stresses. Thus, process 200 may be optimized by adjusting microwave exposure power and time to increase friability and surface area of the ore while mitigating oxidation of copper compounds within the ore.

To mitigate oxidation of copper compounds during application step 230, step 230 may occur in a reducing atmosphere—e.g., in the presence of carbon monoxide gas or other reducing agents. In addition fluids may be added to the ore during step 230 to increase heat-induced stresses within the ore, as described above in connection with process 100.

In accordance with process 200, after the ore has been exposed to microwave energy, the ore is submitted to milling process 240 to further reduce the size of the ore. In accordance with an exemplary embodiment of the present invention, the ore is milled to an average particle size of about 65 mesh. During step 240, ground ore is mixed with water to form a slurry.

Slurry from mill step 240 is sent to separation step 250, where slurry particles containing copper materials are separated from other particles in the slurry. In accordance with an exemplary embodiment of the present invention, copper sulfide materials are separated from the slurry using a flotation process.

The copper sulfide materials from step 250 are sent to first refinement step 260 to separate the copper from other materials. In accordance with an exemplary embodiment of the present invention, the copper sulfide material is exposed to a high temperature furnace (e.g., a smelter) to remove the non-copper compounds.

In accordance with an exemplary embodiment of the present invention, copper material from step 260 is exposed to second refinement step 270 to further refine the copper (e.g., to remove additional impurities). Step 270 may include any process configured to remove impurities from copper. In accordance with an exemplary aspect of the present embodiment, the copper is refined using an electrolytic refining process.

Process 200 may optionally include analysis step 280 to measure an amount of copper present in the ore. Similar to step 170 of process 100 described above, analysis step 280 (which may be the same as analysis step 170) may be performed before or after mine step 210 to determine whether an ore sample should be processed using either of processes 100 or 200.

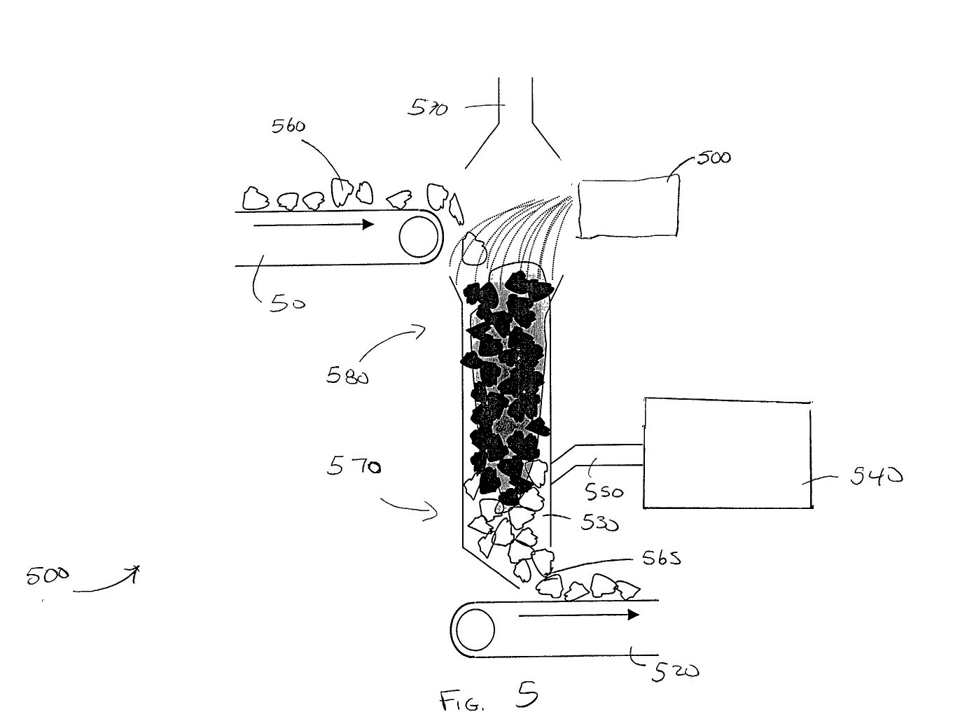

FIG. 5 illustrates an apparatus 500 configured to apply microwave energy to an ore sample (e.g., ore 560) in a continuous mode, in accordance with an alternate embodiment of the present invention. Apparatus 500 generally includes a first conveyor 510, a second conveyor 520, a chamber or chute 530 interposed between conveyors 510 and 520, a microwave energy source 540, and a microwave guide 550. In accordance with the exemplary embodiment of the present invention illustrated in FIG. 5, first conveyor 510 feeds ore 560 to chute 530, and second conveyor 520 receives ore 560 from chute 530 and transports ore 560 away from chute 530. Conveyors 510 and 520 may include typical ore conveying apparatus. Although not illustrated, apparatus 500 may suitably be enclosed to prevent undesired emission of electromagnetic energy.

Chute 530 is suitably configured to retain an amount of ore 560 for a predetermined amount of time before releasing ore 560 to second conveyor 520. To this end, chute 530 may include a latch that is interposed between chute 530 and conveyor 520 to prevent ore 560 from reaching conveyor 520 until the latch is released.

In accordance with one exemplary embodiment of the present invention, chute 530 is configured to retain ore 560 within chute 530 for a predetermined amount of time by choke feeding ore 560 through chute 530. In accordance with one aspect of this embodiment, a residence time that ore 560 spends within chute 530 is controlled by manipulating a feed rate of ore 560 to chute 530, a size of an opening 565 through which ore 560 exits chute 530, or a combination thereof.

In accordance with an exemplary embodiment of the present invention, microwaves from generator 540 are introduced via waveguide 550 to chute 530 near a bottom region 570 of chute 530. Introducing microwaves at bottom region 570 of chute 530 facilitates heating of ore 560 within region 570 and above region 570. In particular, as sulfide and copper compounds react (e.g. to form oxidized materials) in the presence of applied microwaves, a plasma is formed near region 570. The plasma, including exited gas ions, radicals, and molecules, rises toward a top region 580 of chute 530, heating ore 560 within region 580. As discussed above, retaining the plasma within chute 530 allows addition heating of ore 560 per amount of microwave energy applied to ore 560. This additional heating facilitates comminution, further oxidation of sulfide materials, and/or copper recovery in subsequent extraction processing.

Chute 530 may be configured in a variety of forms and may be formed of any material that does not transmit microwave energy and sufficiently resists abrasion. For example, chute 530 may be substantially cylindrically shaped as illustrated in FIG. 5 and formed of stainless steel or other metals.

The formation of plasma may be detrimental to apparatus 500. In particular, the plasma, including charged particles, may be attracted to a magnetron located within generator 540. If the plasma is allowed to reach generator 540, it may cause damage to generator 540. Accordingly, material that is transparent to microwaves and impervious to the plasma (e.g., silica, alumina, or the like) may suitably be interposed between chute 530 and generator 540. In addition, potential plasma-induced damage to generator 540 may be mitigated by employing an arc detector configured to shut off power to generator 540 upon detection of an electrical arc.

High power microwave application to ore 560 may generate SO₂ or other pollutants. Accordingly, apparatus 500 may optionally include a scrubber (e.g., a sulfur dioxide scrubber) to prevent unwanted emission of pollution. In addition, apparatus 500 may include a fluid application device 500. Device 500 is configured to supply water or other fluid to ore 560 within chute 530. As noted above, application of such fluid facilitates mineral liberation and reduces unwanted emission of microwaves and inhibits plasma formation at the top of the chute.

In accordance with an alternate embodiment of the present invention, chute 530 may include a crushing device such as a jaw crusher. In accordance with this embodiment of the invention, microwaves are introduced to chute 530 above a regions where ore 560 is crushed.

Although the present invention is set forth herein in the context of the appended drawing figures, it should be appreciated that the invention is not limited to the specific form shown. For example, while the microwave application devices are illustrated with a single wave guide coupled to a chamber, multiple wave guides may be attached to a single chamber in accordance with the present invention. Various other modifications, variations, and enhancements in the design and arrangement of the method and apparatus set forth herein, may be made without departing from the spirit and scope of the present invention as set forth in the appended claims.

We claim:

1. An apparatus for facilitating recovery of desired materials from ore; said apparatus comprising:
a microwave generator configured to supply an amount of energy to or proximate the ore to form a plasma; and
a waveguide configured to direct microwaves from said generator to the ore.

2. The apparatus according to claim 1, further comprising a chute, wherein said chute is configured to retain the plasma proximate the ore for a period of time.

3. The apparatus according to claim 2, further comprising a scrubber proximate said chute, wherein said scrubber is configured remove at least a portion of pollutants in effluent from said chute, said pollutants resulting from application of energy from said microwave generator.

4. The apparatus according to claim 1, further comprising a fluid application device.

5. The apparatus according to claim 1, further comprising a conveyor.

6. A method for extracting a desired material from an ore, said method comprising the steps of:
mining ore;
crushing ore; and
applying high power microwaves to crushed ore.

7. The method of claim 6, wherein said applying high power microwave step includes applying microwaves of sufficient power to cause oxygen in air to react with mineral compounds within the ore to form a plasma.

8. The method of claim 6, further comprising the step of leaching a mineral from the crushed ore.

9. The method of claim 6, further comprising the step of determining an amount of copper present in the ore.

10. The method of claim 6, further comprising the step of applying sulfur-containing material to the ore.

11. A method for liberating a mineral from an ore, the method comprising the steps of:
mining the ore;
crushing the ore;
applying microwave energy to crushed ore; and
milling the ore.

12. The method according to claim 11, wherein said applying microwave energy step includes applying high power microwave energy to the ore.

13. The method according to claim 11, wherein said applying microwave energy step includes applying sufficient energy to cause compounds within the ore to react with other species to form a plasma.

14. The method according to claim 11, further comprising the step of determining an amount of mineral present in the ore.

15. The method according to claim 11, further comprising the step of exposing the ore to a smelting process.

16. The method according to claim 11, further comprising the step of electrodepositing desired material.
